(19) United States
(12) Patent Application Publication
(10) Pub. No.: US 2025/0358182 A1
(43) Pub. Date: Nov. 20, 2025

(54) INTEGRATED ADDRESS MANAGEMENT OF SOFTWARE DEFINED NETWORKS

(71) Applicant: Schweitzer Engineering Laboratories, Inc.,, Pullman, WA (US)

(72) Inventor: Tristan Lloyd Mullis, Pullman, WA (US)

(73) Assignee: Schweitzer Engineering Laboratories, Inc.,, Pullman, WA (US)

(21) Appl. No.: 18/668,566

(22) Filed: May 20, 2024

(51) Int. Cl. H04L 41/082; H04L 41/08

(52) U.S. Cl. CPC H04L 41/082; H04L 41/0886

(57) ABSTRACT

The present disclosure pertains to systems and methods for monitoring and configuring a software-defined network (SDN). A system may include a communication interface to communicate a plurality of communication flows to a plurality of network devices in the SDN and to receive information from the plurality of network devices related to traffic in the SDN between a plurality of hosts. A configuration subsystem may generate the plurality of communication flows based on a planned configuration. A monitoring subsystem may monitor information from the plurality of network devices related to traffic in the SDN to identify a change to at least one aspect of the planned configuration. An operator-interface subsystem to generate an alert regarding the change. The configuration subsystem may implement an update to the planned configuration based on the change.

### TECHNICAL FIELD

The present disclosure pertains to systems and methods for automating the configuration and maintenance of a software-defined network (“SDN”). More specifically, but not exclusively, the present application relates to detection of changes in operational addresses of equipment in an SDN.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a conceptual representation of an SDN system 100, including a control plane, a data plane, and a plurality of data consumer/producer devices consistent with embodiments of the present disclosure.

FIG. 2A illustrates a flow chart of a method of monitoring an SDN consistent with embodiments of the present disclosure.

FIG. 2B illustrates a flow chart of another embodiment of a method of monitoring an SDN consistent with embodiments of the present disclosure

FIG. 3 illustrates a block diagram of a system including an SDN controller, an SDN comprising a plurality of network devices, and a plurality of hosts consistent with embodiments of the present disclosure.

### DETAILED DESCRIPTION

In an SDN, a controller may regulate communications on the network. SDN networking technologies offer a variety of advantages, such as deny-by-default security, latency guarantees, deterministic transport capabilities, redundancy, and fail-over planning, etc. An SDN allows a programmatic change control platform, which allows an entire communication network to be managed as a single asset, simplifies the understanding of the network, and enables continuous monitoring of a network. In an SDN, the systems that decide where the traffic is sent (i.e., the control plane) are separated from the systems that perform the forwarding of the traffic in the network (i.e., the data plane).

An SDN controller provides centralized configuration and situational awareness. It may perform topology discovery, circuit provisioning, and telemetry monitoring. The control plane has three main components, namely a match component, an action component, and a counter component. The match component determines which control plane rules to apply to each packet entering a switch port. After the flow match determination, the action component instructs the switch regarding what it does with the packet. The counter component includes metrics that may be used to monitor the overall status and health of the network. The counter component may be used in connection with a variety of functions (e.g., alarming on bandwidth when a communication channel gets close to saturation, providing metrics (e.g., counters and meters for quality of service, packet counts, errors, drops, or overruns, etc.) for a specified flow, etc.).

The control plane may be used to optimize the usage of network resources by creating specific data flows through the communication network. A data flow, as the term is used herein, refers to a set of parameters used to match and take action based on network packet contents. Data flows may enable dedicated paths based on a variety of criteria and may offer significant control and precision to operators of the network. In contrast, in large traditional networks, trying to match a network-discovered data path with an application-desired data path may be challenging, involving changing configurations in many devices. To compound this problem, many devices' management interfaces and feature sets are not standardized. Further, network administrators often need to reconfigure the network to avoid loops, gain route convergence speed, and prioritize certain classes of applications.

Despite these advantages, the configuration of an SDN may be challenging because each communication flow between hosts must be configured or the traffic between the hosts may be blocked due to the deny-by-default security policy. In some instances, a desired configuration of a network may deviate from the real-world reality of the network. Differences between a desired configuration and the real-world implementation may create potential issues for operators of an SDN. The inventors of the present application have recognized that a controller within an SDN may be automated in various ways consistent with the present disclosure to reduce the burden associated with the configuration and operation of an SDN.

Various embodiments consistent with the present disclosure may operate to offer operators more informed control of the configuration of the network and end devices. Systems and methods consistent with the present disclosure may monitor network devices and end devices and identify differences between a planned configuration and an operational implementation. For example, such differences may include changes in media access control (“MAC”) or Internet Protocol (“IP”) addresses. Upon detection of a difference between the planned configuration and the operational implementation, the operator may be provided a way to update the planned configuration to match the operational implementation, change the operational implementation to match the planned configuration, or not make any changes.

A variety of subsystems may be implemented by an SDN controller consistent with the present disclosure. For example, an SDN controller may include an address (e.g., MAC addresses, IPv4 addresses, IPv6 addresses, etc.) monitoring subsystem to detect addresses associated with network devices and end devices. A comparison subsystem may compare the planned configuration and operational implementation. An operator interface subsystem may provide notices to an operator related to changes in the SDN and receive input from the operator about reconciling discrepancies. An end point configuration subsystem may update SDN flows based on operator input related to discrepancies between the planned configuration and the operational implementation.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once unless otherwise specified.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described may be implemented as software modules or components. As used herein, a software module or component may include any type of computer instruction or computer-executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc. that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory computer and/or machine-readable medium having stored thereon instructions that may be used to program a computer (or another electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMS, EPROMS, EEPROMs, magnetic or optical cards, solid-state memory devices, or other types of machine-readable media suitable for storing electronic and/or processor-executable instructions.

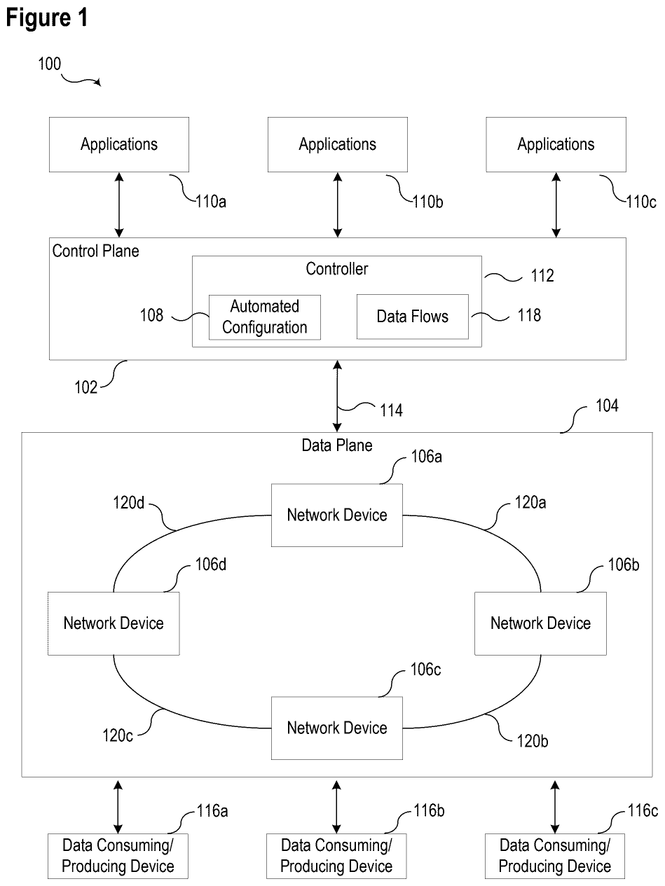

FIG. 1 illustrates a conceptual representation of an SDN system 100, including a control plane 102, a data plane 104, and a plurality of data consumer/producer devices 116a-116c consistent with embodiments of the present disclosure. The control plane 102 directs a plurality of data flows through the data plane 104. More specifically, a controller 112 may communicate with a plurality of network devices 106a-106d via an interface 114 to establish data flows between devices. The controller 112 may specify rules for routing traffic through the data plane 104 based on a variety of criteria.

The data plane 104 includes the plurality of network devices 106a-106d in communication with one another via a plurality of physical links 120a-120d. In various embodiments, network devices 106a-106d may be embodied as switches, multiplexers, routers, and other types of network devices. The physical links 120a-120d may be embodied as Ethernet, fiber optic, coaxial cable, and other forms of data communication channels and media. As illustrated, the physical links 120a-120d between the network devices 106a-106d may provide redundant connections such that a failure of one of the physical links 120a-120d is incapable of completely blocking communication with an affected network device. In some embodiments, the physical links 120a-120d may provide an N−1 redundancy or better.

The data consuming/producing devices 116a-116c may represent a variety of devices within that produce or consume data. For example, data-consuming/producing devices 116a-116c may be embodied as a pair of transmission line relays configured to monitor an electrical transmission line. The transmission line relays may monitor various aspects of the electric power flowing through the transmission line (e.g., voltage measurements, current measurements, phase measurements, synchrophasors, etc.) and may communicate the measurements to implement a protection strategy for the transmission line. Traffic between the transmission line relays may be routed through the data plane 104 using a plurality of data flows 118 implemented by controller 112. Data consuming/producing devices 116a-116c may be embodied by a wide range of devices consistent with embodiments of the present disclosure.

Applications 110a-110c may represent a variety of applications operating in an applications plane. In the SDN architecture illustrated in FIG. 1, controller 112 may expose an application programming interface (API) that applications 110a-110c can use to configure the data plane 104. In addition to an API, other mechanisms may be used to configure the data plane 104. Controller 112 may interface with the data plane 104 and identify communication flows while the control logic resides in the applications 110a-110c. The configuration of controller 112 and applications 110a-110c may be tailored to meet a wide variety of specific needs. Some needs may be specific to electric power systems because of requirements to conform to standards set by various authorities. Such standards may include standards associated with critical infrastructure, as identified by the United States Cybersecurity & Infrastructure Security Agency (CISA).

Data consuming/producing devices 116a-116c may transmit information using network devices 106a-106d. The data from data consuming/producing devices 116a-116c may be routed by data plane 104 according to the plurality of data flows 118 specified by controller 112. Network devices 106a-106d may comprise switches, routers, and other equipment to transmit data through data plane 104.

Controller 112 may implement various features and methods described herein to reduce the burden associated with the configuration and operation of system 100. In various embodiments, controller 112 may detect changes in the addresses of devices (e.g., data consuming/producing devices 116a-116c, network devices 106a, 106b, 106c, 106c, etc.) in system 100.

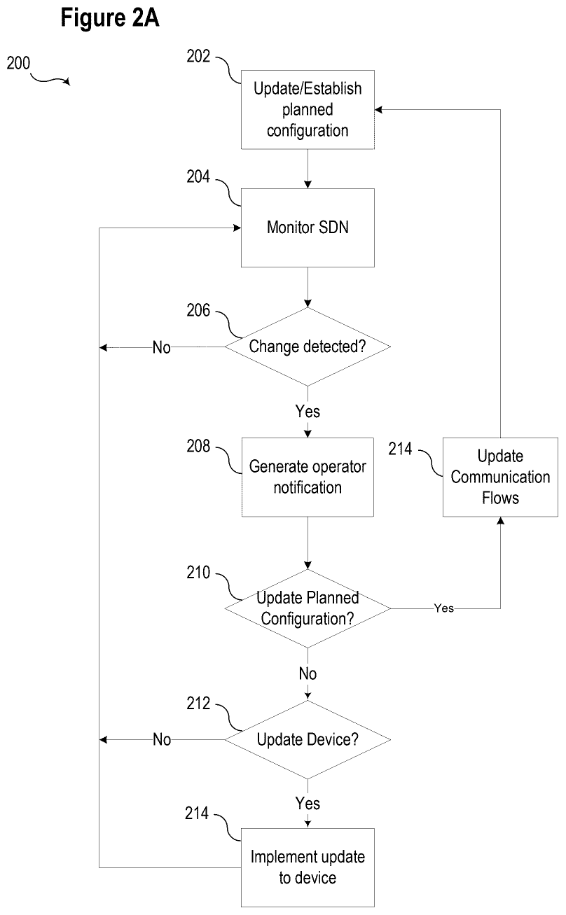

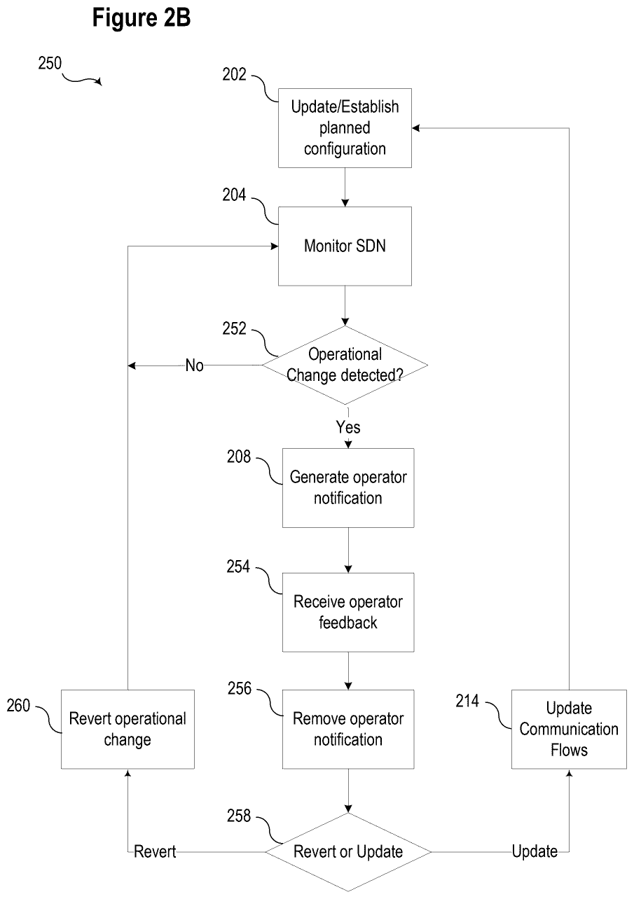

FIG. 2A illustrates a flow chart of a method 200 of monitoring an SDN consistent with embodiments of the present disclosure. At 202, a planned configuration may be established or updated. The planned configuration may include information about device identifiers (e.g., IPv4 or IPv6 addresses, MAC addresses, etc.), communication flows, failover paths, performance metrics to track, etc. The SDN may be programmed, both at the outset and to reflect any changes implemented during operation, at 202.

At 204, method 200 may monitor the SDN. Monitoring the SDN at 204 may involve identifying packets routed between devices according to communication flows, monitoring performance metrics, and monitoring other characteristics of the SDN. Such monitoring may include comparing addresses of devices in the SDN to the planned configuration.

At 206, method 200 may determine if a change is detected. A change may arise from a configuration change to a piece of equipment (e.g., a change to an IP address), replacement of a device, or addition of a new device. Substituting or adding new devices may result in new MAC addresses being introduced to the SDN. Such changes may be detected at 206, and if no changes are detected, method 200 may return to 204. A change of the planned configuration (e.g., changes to one or more device addresses) may be detected at 206.

If changes are detected at 206, method 200 may progress to 208 and generate an operator notification. The operator notification may take a variety of forms. In some embodiments, the notification may comprise a message (e.g., an email or a text message), a notification sent through an application on a computing device, etc. The notification may include an identification of the detected change and the equipment involved.

At 210, method 200 may determine if an update to the planned configuration is to be implemented. In some embodiments, the determination at 210 of whether to update the planned configuration may be based on a response from an operator to the notification generated at 208. For example, when a substitute device is connected to an SDN, the notification may prompt the operator to replace the MAC address of the old device with the MAC address of the new device.

At 214, communication flows impacted by the update to the planned may be updated. The implementation of changes in the planned configuration may be automated to ease the configuration burden imposed on an operator. For example, where a replacement device is connected in place of a retiring device, at 214 the identifiers associated with the new device may be updated to replace the corresponding identifiers associated with the retiring device. Once the communication flows are updated, method 214 may return to 202, where the planned configuration may be updated.

At 212, method 200 may determine whether any device settings are to be updated. For example, the change detected at 206 may be an inadvertent change to the IP address of a device in the SDN. If a device is updated, the change may be remedied by reverting the IP address to the previous value at 212. After updating the device at 212, method 200 may return to 204 and continue to monitor the SDN for other changes. If a change is to be implemented, it may be done at 214, and once the change is complete, method 200 may return to 204.

FIG. 2B illustrates a flow chart of another embodiment of a method 250 of monitoring an SDN consistent with embodiments of the present disclosure. Several elements of method 200 illustrated in FIG. 2A are also present in method 250. The common elements operate in a similar manner and are not described in detail.

Method 250 may determine at 252 whether an operational change is detected. An operational change may include, among other things, changes to an IP address. For example, the IP address of a device may change from 10.1.1.100 (as specified in the planned configuration) to 10.1.1.101.

Detection of an operational change may result in the generation of an operator notification at 208. In some embodiments, the operator notification may comprise a visual identifier displayed on a graphical user interface. For example, an affected piece of equipment may be displayed using a different color (e.g., red) from unaffected pieces of equipment. At 254, operator feedback be received in response to the operator notification. Operator feedback may received in a variety of ways. After operator feedback is received at 254, the notification may be removed at 256.

Based on the operator feedback, system 250 may either revert the operational change or update the planned configuration. If a user reverts the change, the operational change may be revered at 260. Continuing the example above, if the user feedback indicates that the change should be revered, the IP address of the device may be reverted to 10.1.1.100. Alternatively, if the user feedback directs method 250 to update the planned configuration, any impacted communication flows may be updated at 214.

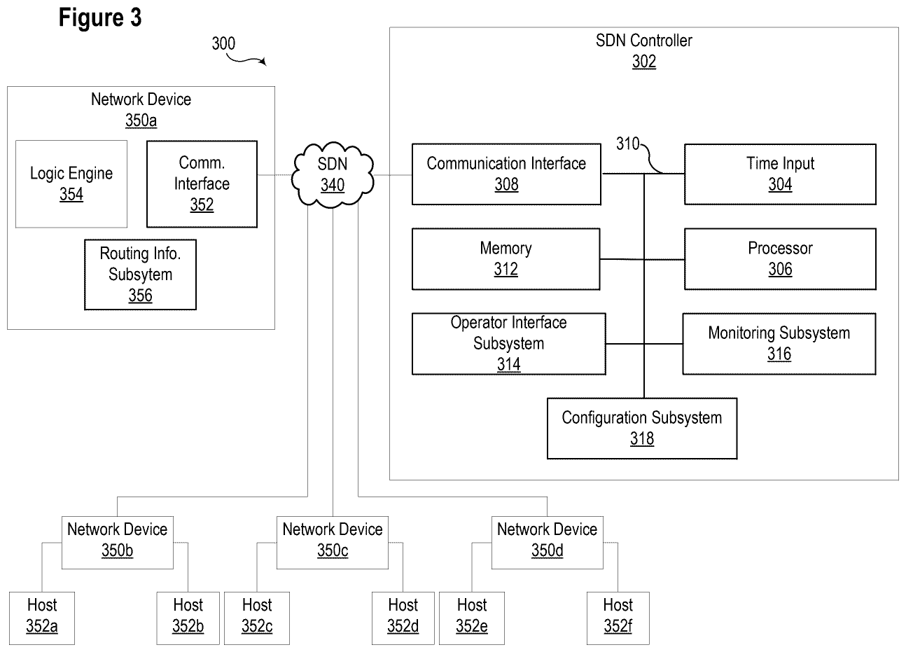

FIG. 3 illustrates a block diagram of a system 300, including an SDN controller 302, an SDN 340 comprising a plurality of network devices 350a-d, and a plurality of hosts 352a-352f consistent with embodiments of the present disclosure. In some embodiments, system 300 may be implemented using hardware, software, firmware, and/or any combination thereof. Moreover, certain components or functions described herein may be associated with other devices or performed by other devices 352a-f. The specifically illustrated configuration is merely representative of one embodiment consistent with the present disclosure.

SDN controller 302 includes a communication interface 308 configured to communicate with SDN 340 and network devices 350a-d. Communication interface 308 may facilitate communications with multiple devices and may comprise more than one physical interface. SDN controller 302 may further include a time input 304, which may be used to receive a time signal (e.g., a common time reference), allowing SDN controller 302 to apply a time-stamp to received data. In certain embodiments, a common time reference may be received via communication interface 308, and accordingly, a separate time input may not be required. One such embodiment may employ the IEEE 1588 protocol. A data bus 310 may facilitate communication among various components of SDN controller 302.

Processor 306 may be configured to implement instructions related to the systems and methods described herein. Processor 206 may process communications received via communication interface 308 and may coordinate the operation of the other components of SDN controller 302. Processor 306 may operate using any number of processing rates and architectures. Processor 306 may be configured to perform any of the various algorithms and calculations described herein. Processor 306 may be embodied as a general-purpose integrated circuit, an application-specific integrated circuit, a field-programmable gate array, and/or any other suitable programmable logic device.

Memory 312 may store instructions to be executed by processor 306. Memory 312 may comprise random access memory (RAM) and non-volatile storage. Memory 312 may be in communication with processor 306 using bus 310. Instructions stored by memory 312 may include the processes and algorithms disclosed herein related to routing and processing data packets with SDN 340.

An operator-interface subsystem 314 may receive various types of information relating to configuring SDN 340 from an operator. In some embodiments, the operator-interface subsystem 314 may facilitate the establishment of a planned configuration. Operator-interface subsystem 314 may allow operators to establish and modify data flows between hosts 352a-352f, enable or disable various types of communication, implement failover contingencies, etc. Still further, operator-interface subsystem 314 may also provide alerts related to changes in SDN 340 and/or other connected devices, such as hosts 352a-352f. Such alerts may help to ensure that the operator maintains control over the configuration of system 300. An alert may allow an operator to approve detected changes, revert changes to a device, or perform other actions in response to detected changes.

A monitoring subsystem 316 may monitor information received from network devices 350a-350d and related to traffic in SDN 340 to identify a change to an aspect of the planned configuration. The change may be the result of replacing a device, a configuration change, or an error. A new device to SDN 340 will introduce a new MAC address and may be detected as a change by system 300. In another example, an operator may inadvertently change an IP address on a host device 352a-352f that may be detected as a change by system 300. As discussed above, an operator may be alerted to such changes and may approve changes to the planned configuration or take other action (e.g., reverting the change so that system 300 continues to operate according to the planned configuration. Monitoring subsystem 316 may operate continuously during operation of system 300. Continuous operation of system 300 in operation may ensure that the planned configuration matches the actual configuration of system 300 over time. The monitoring may occur concurrently with operation of system 300. Detection of change may occur continuously and automatically without operator intervention. Such monitoring may further safeguard system 300 from inadvertent and/or potentially malicious changes.

Configuration subsystem 318 may be configured to generate a variety of communication flows in SDN 340. The configuration subsystem 318 may specify the configuration of a variety of intermediate devices (e.g., routers, switches, multiplexers, etc.), connecting communicating hosts. Configuration subsystem 318 may implement traffic flows corresponding to a planned configuration of system 300. Further, if a change to the planned configuration is detected and the change is approved by an operator, configuration subsystem 318 may update impacted flows. To ease the burden associated with operation of system 300, configuration subsystem 318 may implement such changes automatically upon approval by an operator.

Network device 350a is illustrated in greater detail than the other network devices 350b-c; however, network devices 350b-350d may include some or all of the same features and elements. Each of the network devices 350a-d may include a communication interface 352, a logic engine 354, and a routing information subsystem 356. The communication interface 352 may facilitate communications with multiple devices, including one or more hosts and SDN controller 302. In various embodiments, the communication interface 352 may be configured to communicate via a variety of communication links, including Ethernet, fiber optic, and other forms of data communication channels.

Routing information subsystem 356 may be configured to implement a plurality of communication flows received from SDN controller 302. In some embodiments, the routing information subsystem may include a routing table, a routing information base, a forwarding table, etc.

Logic engine 354 may analyze data processed by network device 350a. If the data matches an established communication flow, such data may be routed by network device 350a without analysis; however, if a packet fails to match an established communication flow, the packet may be transmitted to SDN controller 302. For example, an operator may retire a host device with a certain MAC address with a new device that has a different MAC address. The new device may be configured with the same IP address as the retiring device; however, the MAC address may represent a deviation from an established communication flow. Accordingly, logic engine 354 may route packets from the new host device to SDN controller 302 for further analysis by monitoring subsystem 316. A variety of parameters may be monitored to detect changes, including MAC addresses, IP addresses, etc.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system to monitor and configure a software-defined network (SDN), comprising:
a communication interface to:
communicate a plurality of communication flows to a plurality of network devices in the SDN; and
receive information from the plurality of network devices related to traffic in the SDN between a plurality of hosts;
a configuration subsystem to generate the plurality of communication flows based on a planned configuration;
a monitoring subsystem to monitor information from the plurality of network devices related to traffic in the SDN to identify a change to at least one aspect of the planned configuration; and
an operator-interface subsystem to generate an alert regarding the change;
wherein the configuration subsystem is further configured to implement an update to the planned configuration based on the change.

2. The system of claim 1, wherein the change to at least one aspect of the planned configuration comprises a change to an identifier of a device in communication with the SDN.

3. The system of claim 2, wherein the identifier comprises an Internet protocol (IP) address.

4. The system of claim 2, wherein the identifier comprises a media access control (MAC) address.

5. The system of claim 1, wherein the configuration subsystem is further configured to update at least one of the plurality of communication flows based on the change.

6. The system of claim 1, wherein the operator-interface subsystem is further configured to receive approval of the update prior to implementation of the update.

7. The system of claim 1, wherein the configuration subsystem is further configured to update a setting of a host based on the change.

8. The system of claim 1, wherein the monitoring subsystem is further configured to monitor information from the plurality of network devices to identify the change concurrent with operation of the SDN.

9. The system of claim 1, wherein the monitoring subsystem is further configured to identify the change to at least one aspect of the planned configuration without operator intervention.

10. The system of claim 1, wherein information from the plurality of network devices related to traffic in the SDN comprises a plurality of packets received from the plurality of network devices that fail to match the plurality of communication flows.

11. A method of monitoring and configuring a software-defined network (SDN), comprising:
communicating, using a communication interface, a plurality of communication flows to a plurality of network devices in the SDN;
receiving, using the communication interface, information from the plurality of network devices related to traffic in the SDN between a plurality of hosts;
generating, using a configuration subsystem, the plurality of communication flows based on a planned configuration;
monitoring, using a monitoring subsystem, information from the plurality of network devices related to traffic in the SDN to identify a change to at least one aspect of the planned configuration;
generating, using an operator-interface subsystem, an alert regarding the change; and
implementing, using the configuration subsystem, an update to the planned configuration based on the change.

12. The method of claim 11, wherein the change to at least one aspect of the planned configuration comprises a change to an identifier of a device in communication with the SDN.

13. The method of claim 12, wherein the identifier comprises an Internet protocol (IP) address.

14. The method of claim 12, wherein the identifier comprises a media access control (MAC) address.

15. The method of claim 11, further comprising updating, using the configuration subsystem, at least one of the plurality of communication flows based on the change.

16. The method of claim 11, wherein the operator-interface subsystem is further configured to receive approval of the update prior to implementation of the update.

17. The method of claim 11, wherein the configuration subsystem is further configured to update a setting of a host based on the change.

18. The method of claim 11, further comprising monitoring, using the monitoring subsystem, information from the plurality of network devices to identify the change concurrent with operation of the SDN.

19. The method of claim 11, further comprising identifying, using the monitoring subsystem the change to at least one aspect of the planned configuration without operator intervention.

20. The method of claim 11, wherein information from the plurality of network devices related to traffic in the SDN comprises a plurality of packets received from the plurality of network devices that fail to match the plurality of communication flows.
